(19) United States
(12) Patent Application Publication
(10) Pub. No.: US 2012/0183121 A1
(43) Pub. Date: Jul. 19, 2012

(54) METHOD OF RADIO-SYNTHETIC EXAMINATION OF SPECIMENS

(75) Inventors: Jean-Bernard Perrin, Jacob Bellecombette (FR); Jean-Robert Philippe, Moretel de Mailles (FR)

(73) Assignee: SPECTROSCAN SARL, Crolles (FR)

(21) Appl. No.: 13/499,388

(22) PCT Filed: Sep. 30, 2009
(86) PCT No.: PCT/FR2009/001168

§ 371 Date: Mar. 30, 2012

(51) Int. Cl. H05G 1/64

(52) U.S. Cl. 378/41

(57) ABSTRACT

The invention relates to a method of continuous non-destructive examination of specimens by so-called radio-synthesis, which can be integrated into the process for managing the life cycle of said specimens. This method operates by means of at least one X-ray source and of at least one digital sensor forming a pair with said source, source and sensor moving along opposite and homothetic trajectories inside a motion space, for each real-time generation of at least one cross section of each specimen.

### FIELD OF THE INVENTION

The invention relates to a method of nondestructive and continuous examination of specimens, called radio-synthesis examination, that can be incorporated into the lifecycle management process for said specimens. This method works by means of at least one source of x-rays and at least one digital sensor forming a couple with said source, the source and the sensor moving on opposite and homothetic trajectories inside a space of motion, for each real-time generation of at least one section of each specimen.

‘Lifecycle of the specimen’ means the methods and technical means implemented from its design (CAD) up to its industrial production (MPM) in series.

### STATE OF THE ART

Among the methods of non destructive testing of objects, tomography is already known. The principle of tomography consists in rotating a specimen around an axis and, by means of a x-ray source and a x-ray sensor located on both sides of the same axis, in carrying out for each angular portion of this rotation one to several projections through x-ray transmission from the source to the sensor through said specimen.

The method of x-ray tomography finally restores the space image (3D) of the specimen from the projections carried out beforehand by means of an algorithmic calculation of filtered back projection. It is then possible to carry out virtual sections of the object to be examined in the three planes X, Y and Z of this volume and at various levels.

The main disadvantage of these systems is a very long time for acquiring the images (approximately 1 h for each object to be tested) because of the great number of necessary photographs and an equivalent or longer time for rebuilding the final volume.

It is also known tomosynthesis methods of testing and rebuilding objects whose principle consists in:
using a x-ray source moving before the object according to a flat, linear, circular or elliptic acquisition trajectory and a digital sensor, associated with said source, moving behind the object on a trajectory identical and parallel to that of the source,
carrying out few two-dimensional projections (2D) of the object which are distributed in a restricted angular field, these projections being acquired by and on the digital sensor and in
rebuilding a median and horizontal virtual section of the examined object by means of the few two-dimensional projections (2D).

These tomosynthesis methods make it possible to rebuild a section of the object to be tested as well as possible from some projections. This technique is particularly well adapted to flat products (electronic cards for example). On the other hand, for the objects having a non-flat shape, a pollution is introduced because of the presence of material in the other planes but the relevant section.

The state of the art includes many documents describing tomosynthesis devices and methods.

A first document (patent U.S. Pat. No. 6,459,760) relates to a method and an automated robot device for carrying a nondestructive real-time testing of an object to be analyzed by means of x-rays, in which the x-ray source and the sensor are mounted on a hinged arm, mobile around the object. A mobile support is integral with an articulated robot arm and comprises a first and a second part of said support, these two parts being spaced from one another in order to define a space between them, dimensioned to receive the object to be tested. The x-ray source is integral with the first support part and is adapted to project a beam along an axis. The sensor or detecting panel is integral with the second support part, placed substantially perpendicular to the beam axis. Said robot device, associated with the method, can examine the object to be tested by operating the x-ray source and the detecting panel relative to said object and by real-time providing images of said object to a data processing system connected to the imagery system of the robot device (source and detecting panel), so that it is automatically controlled.

Another document (patent application FR 2 835 949) relates to a method for the multiplane rebuilding synthesis of an object by means of a x-ray source, this source moving according to a linear trajectory. The method includes a step of decomposition of the volume of the object in n fan-shaped independent two-dimensional planes, a step of anisotropic regularization on each of the n planes, a step of regularization among the n planes and a step of three-dimensional rebuilding of the object by using an algorithm implementing an algebraic method.

However, the known tomosynthesis methods whose x-ray source moves according to a plane trajectory, i.e. it is located in a plane, results in practice in many phenomena detrimental to a good three-dimensional (3D) rebuilding of the object to be rebuild from the two-dimensional (2D) sectional planes, phenomena which generate as many defects on the three-dimensional (3D) rebuilt object which are, for example, a hazy effect in the direction of displacement of the x-ray source and/or a vertical deformation of the object rebuilt in the third dimension and/or “noises” of data acquisition in each of the axial directions X, Y, Z caused by an absence of selection of the two-dimensional (2D) images obtained, “noises” which are still present during the object rebuilding and which damage the quality of this rebuilding,

Moreover, because the number of two-dimensional (2D) projections and the aperture of the X-radiation are limited, the methods for rebuilding the object in three dimensions (3D) from two-dimensional (2D) projections must be combined with operations of regularization in order to be able to get an improved rebuilding of the object.

Lastly, the data processing system receiving the digital data of the mobile detector corresponding to the two-dimensional projections for treating them and rebuilding the object in three dimensions (3D), implements algorithms functioning according to an analytical mode or an algebraic mode, these two modes not being able to sufficiently correct the collected data corresponding to the two-dimensional projections of said object in order to eliminate for example hazy and/or vertical deformation phenomena and/or “noises” and/or other noted defects and, consequently, which results in inaccurate rebuilding operations for said object.

### OBJECTS OF THE INVENTION

The objects of the invention aim at implementing already known and/or new technical means which, combined in a new way, eliminate the disadvantages perceptible in the state of the art, in particular those detrimental to the rebuilding and/or the analysis and/or the radio-synthetic testing of a specimen.

‘specimen’ means any type of object or set of natural or synthetic objects, or all or part of a human being, an animal, a plant or a mineral.

Among all the objects of the invention, introduced in the following description, some are particularly essential such as:
the selection of the best two-dimensional projections of the specimen, obtained by tomosynthesis by means of appropriate sectional planes,
the search or the creation of space positions for the x-ray source and its sensor, relative to the specimen to be examined (by getting out of the principle of a flat trajectory a priori, for the x-ray source and the associated sensor) and by determining, point by point, an optimal trajectory for the three dimensions for said source and said sensor, by giving the best projections of the specimen transformed into right data, themselves exploited by appropriate algorithms, providing exact analyzes and/or testing operations from the faithful reproduction of the specimen,
the design of a method for detecting defects of a specimen in three dimensions and in real time, which is integrated in an organizational cycle such as PLM,

### BRIEF DESCRIPTION OF THE INVENTION

Consequently, the invention relates to a method of continuous examination of specimens with digital real-time 3D radiography by means of at least one x-ray source and at least one digital sensor coupled with said source, both of them moving according to opposite and homothetic trajectories, characterized in that

I. in a first phase, it is generated a digital model of the standard specimen to be tested and a digital model of an optimal trajectory in the space of motion of the x-ray source and the associated sensor for acquiring radiographic images, selected as the most relevant, by carrying out the sequence of the following steps:
A—In a first step, called “step of design and/or definition of the standard specimen”, it is carried out:
   A1: the 3D parameter setting for the specimen;
   A2: the 3D cartography of the laws of x-ray absorption by the various substances composing the specimen;
   A3: the definition of at least one 3D sectional plane of the specimen.
B—In a second step, called “step of transfer and transformation of the parameters”, it is carried out:
   B1: the transfer and the transformation of the parameters of the step (A);
   B2: the distribution in the volume of the specimen of the laws of x-ray absorption by the various substances;
   B3: the calculation of the co-ordinates of at least one 3D sectional plane of the step A3.
C—In a third step, called “step of simulation and optimization”, it is carried out the simulation and the search of the best projections necessary to the rebuilding of at least one 3D sectional plane;
   C1: from the data resulting from the step (B) by simulating radiographic projections of said specimen;
   C2: by controlling the simulation of the projections by means of an optimization algorithm which selects the most relevant images of the sectional plan(s).
D—In a fourth step, called “step of trajectory generation”, it is carried out the generation of the optimal trajectory for the x-ray source and sensor in their space of motion, from the set of the photograph positions obtained at the end of the step C2.
E—In a fifth step, called “step of integration of the motion of acquisition, it is generated at least one command file intended for a mechanical device carrying out the continuous motion of acquisition of the radiographic images previously selected.

II. In a second phase, it is carried out the radiographic image acquisition for real specimens, in real time and continuously, by using the optimal trajectory of the x-rays source and the associated sensor, previously transferred, for real-time and continuously testing these real specimens.

III. In a third phase, the radiographic images acquired at the time of the phase II constitute the input parameters for an algorithm of real-time rebuilding of the 3D sectional plane or planes of the tested real specimen.

IV. In a fourth phase, the images the 3D sectional plane or planes are exploited by an image analysis software and/or by an operator, a natural person.

In the description of the object of the invention, the terms 3D, three-dimensional and the expression “in three dimensions” are regarded as synonyms and can be used indifferently.

### DETAILED DESCRIPTION OF THE INVENTION

The invention relates to a method of continuous nondestructive radio-synthesis examination of specimens by means of at least one x-ray source and of at least one x-ray sensor forming a couple with said source, the source and the sensor moving along opposite and homothetic trajectories inside a space of motion, for each real-time generation of at least one section of each specimen.

The method according to the invention comprises four successive phases, which determine each of the different functions implementing specific means for their result:
the first phase of the method according to the invention first relates to the digital modeling of a standard specimen which either exists naturally in great number such as the living world in the biomedical field or is industrially produced in the technological field, or the use of an theoretical model of CAD type. This modeling is carried out by the sequence of successive steps described thereafter.

At the time of this first phase, the specimen to be modeled creates its own process of analysis, testing and thus modeling via at least one sectional plane defined by the needs identified in the standard specimen for the examination for real specimens to be tested.

This first phase of the method according to the invention also relates to the essential generation of a digital model of optimal trajectory located in the space of motion for the x-ray source and the associated sensor, for the radiographic image acquisition for the specimen to be modeled free of the defects perceived in the state of the art.

The second phase of the method according to the invention relates to the radiographic image acquisition for real specimens to be tested belong to the same type as the digital specimen modeled in the first phase.

This acquisition is carried out in real time and continuously by using the optimal trajectory in the space of motion of the x-rays source and of the associated sensor from the first phase in order to carry out the continuous real-time examination of these real specimens.

The third phase is a phase of real-time rebuilding of the 3D sectional plane or planes of the tested specimen(s) from the radiographic images acquired during phase II by a rebuilding algorithm.

The fourth phase is the phase of examination during which the images of the sectional plane(s) are exploited by an image analysis software and/or an operator, a natural person.

The first phase, which is a phase of modeling of the method according to the invention, comprises five steps A to E detailed hereafter and proceeding in order.

Step (A) Called Step of Design and/or Definition of the Specimen

In this first step (A) which comprises three parts carried out in a sequential way, it is carried out:

A1. the parameter setting of the 3D geometry of the standard specimen by means of a suitable software in order to obtain a 3D model of said specimen,

A2. Establishing the 3D cartography of the laws of x-ray absorption by taking account of the space distribution of the various components constituting the standard specimen and

A3. the definition of at least one sectional plane of said standard specimen by means of a three-dimensional graphic visualization software allowing the interactive positioning of this at least one sectional plan in the volume of the standard specimen.

### Parameter Setting of the Geometry of the Standard Specimen

‘Geometry’ of the specimen subjected to a parameter setting means the shape and the dimensions of this complete specimen, as well as those of each of its components and the arrangement of the different components relative to one another.

According to the definition given before and in the method of the invention, the standard specimen can represent the description of an object or a set of objects, of natural or synthetic origin, whose geometry is reproduced or created by means of a suitable software of a known type such as a computer-aided design (CAD) software.

### Formulation of the Laws of X-Ray Absorption for the Various Components of the Standard Specimen

X-rays comply with the usual law of absorption of the luminous rays according to the thickness d of the absorbing material, with an intensity I₀ incident to the x-ray beam and a transmitted intensity I, these criteria being associated in the equation (1) hereafter:

I=I₀ e^{μd} (1)

in which μ is a coefficient of absorption characteristic of the absorbing material and of the wavelength used. This coefficient μ is roughly proportional to the cube of said wavelength.

Apart from the discontinuities mentioned in more details hereafter, the coefficient μ of x-ray absorption is given by the law of Bragg-Pierce:

μ□k Z⁴ λ³ (2)

in which Z is the atomic number, λ the wavelength of the incident beam and k is a factor of proportionality. The formula I=I₀ e^{-μd} is valid only if the mechanism of absorption remains the same, identical to that of the visible light. However, because of the high energy of their photons, the x-rays can be absorbed by a different mechanism: the energy of the x-rays can indeed be sufficient to expulse the electrons from the electron shells of the absorbing element and it is consequently observed a brutal increase in the absorption of x-rays as well as the production of various associated effects resulting from the behavior of x-rays on the material of the standard specimen and of its environment. The curve representing the coefficient of absorption according to the wavelength λ then shows a discontinuity each time the value hν corresponds to the energy of an electron of the absorbing material in which h represents the Planck's constant (6.62.10⁻²⁴) and ν represents the frequency c/λ where c is the speed of light and λ the above-mentioned wavelength (it is thus observed discontinuities for the shells K, L, M etc. . . . ).

The law of x-ray absorption for each component constituting the standard specimen must be formulated: in practice, this law is calculated by using the above-mentioned formulas (1) and (2). It also integrates the behavior of the associated effects induced by the exposure of the material of the standard specimen and of its environment to x-rays.

The densitometric distribution of x-ray absorption is then given for each area of the standard specimen, i.e. for each area of localization corresponding to each component constituting the specimen. The calculated data are then exported to the module of calculation.

From these data given by the laws of x-ray absorption for the components constituting the standard specimen, the cartography 3D of these laws of absorption is obtained either with the help of a software module called “plug-in” which can be integrated in the existing CAD softwares, or with the help of an independent application software tool. In the second case an export is made from the software used for the definition of the geometry, for example a CAD software, and the laws of x-ray absorption are determined in this application software tool.

### Definition of at Least One Sectional Plane of the Standard Specimen.

A 3D graphic visualization software specific to the method according to the invention allows the interactive positioning of at least one sectional plane in the volume of the standard specimen to be examined.

Such 3D graphic visualization softwares are known, but they do not have enough functionalities in order to be exploited at best in the method according to the invention.

Therefore, it is particularly necessary to develop a module of interactive positioning of at least one sectional plane of said specimen in order to ensure the precise positioning thereof. It is also necessary to work with standard file formats. This 3D graphic visualization software or module exploits the data resulting from the software used for the parameter setting of the geometry of the specimen.

At the time of its exploitation, the method according to the invention aims not only at defining the parameters of the specimen to be examined but also at evaluating, by means of at least one sectional plane, drifts, defects and/or anomalies, in particular inside said specimen, whose detected presence would be an immediate and serious alarm for an informed observer who, for example,
in the case of a prototype system, would seek the cause in order to solve it,
in the case of a real specimen taken, for a quality control, from a continuous production line, would put aside said specimen detected as defective and would check by taking other specimens from this chain that the defect or the anomaly is not repetitive,
in the case of a specimen of the living world, would mobilize the intention of an expert in this field or would constitute the base of a modeling system.

According to the method of the invention and the type of examination to be carried out with the method, one or more sectional planes are parameterized.

In the case, for example, when a precise area of the real specimen is likely, in a known manner, to contain defects and/or anomalies which have to be detected, only one sectional plane of said specimen is necessary in order to observe said area with a certain facility for their localization.

As an illustration, some cases can be mentioned, such as the checking of a weld which must be tight in a metallurgical assembly in contact with a liquid or the checking of a piece obtained by mold injection of thermo-fusible polymeric materials a well localized area of which can be the seat of a phenomenon of shrinkage cavitation or the observation of a precise area of a mechanical assembly strongly submitted to important stresses during its exploitation.

If all the real specimen can present defects and/or anomalies, several sectional planes of the specimen are necessary and, consequently, parameterized to detect and locate said defects and/or anomalies.

### Step (B) Called Step of Transfer and Transformation of the Parameters

In this second step called step of transfer and transformation of the parameters, a merging software is implemented which carries out:

B1. the transfer and the transformation of the 3D model of the readable and exploitable standard specimen into a standard format, thus providing the data necessary to an optimization algorithm implemented at the step C.
B2. a merging operation which carries out the definition and the distribution, in the volume of the standard specimen, of the laws of x-ray absorption for the various previously parameterized components (substances) of said specimen.
B3. The calculation of the co-ordinates of the at least one sectional plane defined at the step A3.

The step (B) is a step of formatting and interpretation of all the parameters in the step (A); at the end of the step (B), the parameters formatted and interpreted are transferred to the step (C).

The function of the “merging” software, which is implemented at the step (B), is to carry out a conjunction (link) of the parameters of the step (A) by generating other parameters necessary to their calculation management and their exploitation at the following step (C) of simulation and optimization.

The export of the 3D model of the standard specimen according to (B1) is carried out in a standard format readable and exploitable by a search software integrating the optimization algorithm used at the step (C).

The merging operation according to (B2) carries out the definition and the distribution, in the volume of the standard specimen, of the laws of x-ray absorption for the various components mentioned in the phase (A2) of cartography.

Generally, the X-radiation undergoes a variable absorption when passing through various components of a specimen. Some components like natural gases, some polymers do not absorb x-rays very much. Finally, other components, in particular metal components, have a strong capacity of absorption for the X-radiation: is the absorption of X-radiation by a component is all the more important as its atomic number is high. Therefore, the consequence of the simultaneous presence of associated components with low atomic numbers (organic substances such as proteins made up of carbon, hydrogen, oxygen possibly nitrogen) and with high atomic numbers (metals such as lead, copper or other metals) in a specimen and a particular sectional plane, is that the components with high atomic numbers absorb the X-radiation and almost completely mask the other components with low atomic numbers.

It is thus an essential characteristic of the method according to the invention to be able to obtain a modeling, at the same time very clear and very precise, of the standard specimen as well as of various components appearing in the various sectional planes of said specimen with well marked borders between the components, whatever the atomic number of each component.

Thus, the three-dimensional radio-synthetic method according to the invention appears already under this aspect as faster, more synthetic, more precise, giving section images with an excellent precision free of the defects usually met in the conventional techniques of acquisition and rebuilding such as the conventional tomography, tomosynthesis . . . .

The calculation of the co-ordinates of the at least one sectional plane defined in (A3) of the step (A) is carried out by the computer-aided design (CAD) software which provides a volume standard specimen (3D) which can be oriented in space by rotation and/or translation according to the three axes and in which sectional planes can be defined by the operator by means of only three points whose co-ordinates are in the same reference system XYZ as that of said specimen.

### Step (C) Called Step of Simulation and Optimization

In this third step called step of simulation and optimization, a simulation is carried out and the best projections are searched which are necessary to the rebuilding of said 3D sectional plane(s) previously parameterized by using a search software:

C1. integrating the data resulting from the transfer carried out in the step B and which simulates radiographic projections of said specimen defined from the data transferred by means of a function of ray tracing specific to x-rays,
C2. controlling an optimization algorithm which consists in selecting the photograph sets giving the most relevant images of radiographic projections.

This step of simulation and optimization is based on the use of an optimization algorithm integrated in a search software.

The search software enable to carry out a simulation and to search the best projections necessary to the rebuilding of said 3D sectional plane(s) previously defined.

Among the existing algorithms of optimization which can be implemented in the method according to the invention, one can mention the metaheuristic algorithms, the algorithms of Monte Carlo, and the functional minimization algorithms.

The term ‘metaheuristic algorithm’ refers to families of algorithms aiming at solving a broad range of problems of complex optimization (difficult to solve). The metaheuristic algorithms are iterative stochastic algorithms whose evolution is governed by a function of emulation.

More precisely and in a non exhaustive way, the method according to the invention uses a metaheuristic optimization algorithm such as: particle swarm optimization, ant colony optimization, simulated annealing, path relinking, differential strategy, differential evolution, genetic algorithms, estimation of distribution.

The integration of the data resulting from the transfer in the step (B) is carried out in the first part (C1) of the step (C).

These data makes it possible to simulate radiographic projections of said standard specimen defined from the data transferred thanks to a function of ray tracing specific to x-rays.

### Step (D) Called Step of Trajectory Generation

In this fourth step, called step of trajectory generation, from the set of known photograph positions at the end of the step C, a trajectory in the space of motion is generated which is optimal both for the motion of the x-ray source and the associated digital sensor and for the duration of acquisition of these photographs.

The definition of the trajectory of acquisition thus consists in linking by means of an optimum path the positions of the photographs selected for the rebuilding (summation) of the sectional plan(s).

Within the framework of the invention, for a given specimen and defined sectional planes, there is an optimal trajectory in terms of time of course and time of acquisition.

In the same way, when an optimal trajectory in the space of motion is generated for the x-ray source and the associated sensor, this trajectory can describe the motion necessary to the acquisition of the images useful for the rebuilding of several sectional planes of the standard specimen and this trajectory is in adequacy with the carrying-out of the examination of real specimens.

In a fifth step (E) called “step of integration of the motion of acquisition”, it is generated at least one command file for the physical method carrying out the continuous motion of acquisition of the radiographic images previously selected, and said file is transferred to the system carrying out the motion corresponding to the acquisition trajectory defined at the step D.

The system receiving this motion control program is installed on the on-line control machine for the specimens manufactured.

When all the steps (A) to (E) of the first phase are carried out, the method according to the invention enters the second phase, then the third phase and the fourth phase as indicated hereafter.

In the second phase of the method according to the invention, the acquisition of radiographic images of real specimens are carried out, in real time and continuously, by using the optimal trajectory previously transferred for the continuous real-time examination of said real specimens.

In the third phase of the method according to the invention, the radiographic images acquired in phase II constitute the input parameters of a real-time rebuilding algorithm for 3D sectional planes for the real specimen tested.

In the fourth phase, the images of the 3D sectional plane or planes are exploited by an image analysis software and/or an operator, a natural person, working for example on a testing machine.

The method according to the invention can be integrated for example in the process of product lifecycle management (PLM), on the level of the development of the product i.e. from the phase of design to its phase of production, then on the level of the production of the product or real specimen, in order to test them.

The process of product lifecycle management (PLM) is a corporate strategy which aims at generating, managing and sharing the set of information for the definition, manufacture, maintenance and recycling of an industrial product, throughout its lifecycle, from the feasibility studies to the end of its life.

In particular, the PLM approach is organized around an information system including computer-aided design, technical data management, digital simulation, the computer-assisted fabrication, knowledge management.

The method according to the invention can be applied to very many fields such as those of industrial research, quality control, medical, paramedical, veterinary and pharmaceutical applications, biotechnology applications, micro- and nano-technology, harbor and airport safety applications, and fight against counterfeiting.

1-12. (canceled)

13. Method of continuous examination of specimens with digital real-time 3D radiography by means of at least one x-ray source and at least one digital sensor coupled with said source, the at least one x-ray source and the at least one digital sensor moving according to opposite and homothetic trajectories, comprising:
I. in a first phase, it is generated a digital model of a standard specimen to be tested and a digital model of an optimal trajectory in a space of motion of the at least one x-ray source and of the at least one digital sensor for acquiring radiographic images, selected as most relevant images, by carrying out a sequence of the following steps:
A—in a first step, called “step of design and/or definition of the standard specimen”, it is carried out:
A1: a 3D parameter setting for the standard specimen;
A2: establishing a 3D cartography of laws of x-ray absorption by the various substances composing the standard specimen; and
A3: defining at least one 3D sectional plane of the standard specimen;
B—In a second step, called “step of transfer and transformation of the parameters”, it is carried out:
B1: transferring and the transforming the parameters of the step (A);
B2: distributing in the volume of the specimen of the laws of x-ray absorption by the various substances; and
B3: calculating the co-ordinates of the at least one 3D sectional plane of the step A3;
C—in a third step, called “step of simulation and optimization”, it is carried out the simulation and the search of the best projections necessary to the rebuilding of the at least one 3D sectional plane;
C1: from the data resulting from the step (B) by simulating radiographic projections of said specimen;
C2: by controlling the simulation of the projections by means of an optimization algorithm which selects the most relevant images of the at least one 3D sectional plane;
D—in a fourth step, called “step of trajectory generation”, it is carried out the generation of the optimal trajectory for the x-ray source and sensor in their space of motion, from the set of the photograph positions obtained at the end of the step C2;
E—in a fifth step, called “step of integration of the motion of acquisition, it is generated at least one command file intended for a mechanical device carrying out the continuous motion of acquisition of the radiographic images previously selected;
II. in a second phase, it is carried out the radiographic image acquisition for real specimens, in real time and continuously, by using the optimal trajectory of the x-rays source and the associated sensor, previously transferred, for real-time and continuously testing these real specimens;
III. in a third phase, the radiographic images acquired at the time of the phase II constitute the input parameters for the algorithm of real-time rebuilding of the 3D sectional planes of the tested real specimen; and
IV. in a fourth phase, the images the 3D sectional planes are exploited by an image analysis software and/or by an operator, a natural person.

14. The method according to claim 13, wherein the parameter setting of the 3D geometry of the specimen is carried out by means of a known CAD software in order to obtain a 3D model of the standard specimen.

15. The method according to claim 13, wherein the 3D cartography of the laws of x-ray absorption is carried out by taking account of the space distribution of the various components constituting the standard specimen.

16. The method according to claim 13, wherein the definition of at least one sectional plane of said standard specimen is carried out by means of a 3D graphic visualization software allowing the interactive positioning of this sectional plan in the volume of the standard specimen.

17. The method according to claim 13, wherein the transfer and the transformation of the parameters of the 3D model of the standard specimen is carried out by means of a merging software, providing the data necessary to an optimization algorithm implemented at the step C.

18. The method according to claim 13, wherein the simulation and the search of the best projections necessary to the rebuilding of at least one 3D sectional plane previously parameterized are carried out by means of a search software.

19. The method according to claim 13, wherein the data, resulting from the transfer carried out in the step B, of said specimen are obtained by means of a function of ray tracing specific to the x-rays simulating the radiographic projections.

20. The method according to claim 13, wherein the selection of the most relevant images necessary to the rebuilding of the sectional planes is carried out by means of a metaheuristic optimization algorithm.

21. The method according to claim 13, wherein the set of known photograph positions a trajectory in the space of motion is generated which is optimal both for the motion of the x-ray source and the associated digital sensor and for the duration of acquisition of these photographs.

22. The method according to claim 13, wherein from the volume and x-ray absorption information for the standard specimen and from the information on the positions of the sections to be carried out it is generated from all the directions of space radiographic images by photograph simulation in the direction of the selected at least one 3D sectional plane.

23. The method according to claim 13, wherein a metaheuristic algorithm selects the most relevant photographs necessary to the generation of the selected at least one 3D sectional plane.
